(19) United States
(12) Patent Application Publication
(10) Pub. No.: US 2009/0071760 A1
(43) Pub. Date: Mar. 19, 2009

(54) MACHINEROOMLESS ELEVATOR

(75) Inventor: Kazuhiro Izumi, Shanghai (CN)

Correspondence Address: FOLEY AND LARDNER LLP;SUITE 500, 3000 K STREET NW, WASHINGTON, DC, 20007, US

(73) Assignee: Toshiba Elevator Kabushiki Kaisha

(21) Appl. No.: 12/282,312

(22) PCT Filed: Mar. 14, 2007
(86) PCT No.: PCT/JP2007/055045

§ 371 Date: Sep. 9, 2008

(30) Foreign Application Priority Data
Mar. 14, 2006 (JP) 2006-069284

(51) Int. Cl. B66B 11/04

(52) U.S. Cl. 187/254; 187/250

(57) ABSTRACT

The present invention provides a machineroomless elevator system 100 including an elevator hoist 25 that can be rationally disposed in a limited space in a top part of an elevator shaft 2. In the machineroomless elevator system 100, the elevator hoist 25 is disposed such that a first end thereof provided with a main sheave 26 is above a counterweight 22, and a second end 25a thereof opposite the first end is above the rear end 20c of a cage 20 as viewed from above the elevator shaft 2. Therefore, the degree of freedom of disposing the elevator hoist 25 can be increased, and devices mounted on the top wall of the cage 20 can be easily arranged so that the devices may not interfere with the elevator hoist 25.

### BACKGROUND OF THE INVENTION

1. Field of the Invention

The present invention relates to a machineroomless elevator system including an elevator hoist disposed in a top part of an elevator shaft and, more specifically, to techniques for installing an elevator hoist in a rational arrangement in a limited space in a top part of an elevator shaft.

2. Description of the Related Art

Various machineroomless elevator systems each including an elevator hoist disposed in a top part of an elevator shaft formed in a building have been developed and proposed.

FIGS. 3 and 4 show a machineroomless elevator system 1 disclosed in the following Patent Document No. 1 by way of example. In this known machineroomless elevator system 1 shown in FIGS. 3 and 4, a cage 4 is guided for vertical movement by a right cage guide rail 3R and a left cage guide rail 3L vertically stood in an elevator shaft 2, and a counterweight 6 is guided for vertical movement by a front counterweight guide rail 5f and a rear counterweight guide rail 5r vertically stood along the left wall 2L of the elevator shaft 2. An elevator hoist 7 is disposed in a top part of the elevator shaft 2 at a position above the left wall 4L of the cage 4. The elevator hoist 7 drives a main sheave 8 disposed in a space S between the left wall 2L of the elevator shaft 2 and the left wall 4L of the cage 4, as viewed in a top view of the elevator shaft 2, for rotation about a lateral, horizontal axis.

Main ropes 9 wound round the main sheave 8 have first end parts extended so as to wind round a guide sheave 10, and a right sheave 11R and a left sheave 11L held on lower parts of the cage 4, respectively, and connected to a hitch 12 fixed to the top wall of the elevator shaft 2. Thus, the cage 4 is suspended by the main ropes 9 extended in a 2-to-1 rope arrangement.

second end parts, opposite the first end parts, of the main ropes 9 are wound round a guide pulley 6a held on an upper part of the counterweight 6 and are connected to a hitch 13 attached to a left part of the top wall of the elevator shaft 2. Thus, the counterweight 6 is suspended by the main ropes 9 extended in a 2-to-1 rope arrangement.

Patent Document No. 1: IP-A 2000-44147

### DISCLOSURE OF THE INVENTION

### Problem to be solved by the Invention

In the machineroomless elevator system 1, the elevator hoist 7 extends between a position near the left wall 4L of the cage 4 and a position in the vicinity of the central part of the cage 4 as viewed in FIG. 3 showing the elevator system 1 in a top view. Since large bending moments are exerted on the left cage guide rail 3L, the front counterweight guide rail 5f and the rear counterweight guide rail 5r, respectively, the dimensions of those guide rails 3L, 5f and 5r need to be selectively determined so that the guide rails 3L, 5f and 5r may have sufficient bending rigidities, respectively.

Various devices are mounted on the top wall of the cage 4. Restrictions are placed on the arrangement of those devices to avoid interference between those devices and the elevator hoist 7 when the cage 4 is raised to an upper limit position.

Moreover, as shown in FIG. 3, the positional relation between the elevator hoist 7 and the left cage guide rail 3L obliges the guide pulleys 11R and 11L to be located at positions at a considerable distance toward the front from a lateral line passing the center G of gravity of the cage 4. Therefore, a backward force acts always on the cage 4 to press the cage 4 against the respective front sides of the cage guide rails 3R and 3L. Consequently, vibration s and noise are generated when the cage 4 moves vertically, which is possible to spoil the comfort of passengers in the cage 4.

Accordingly, it is an object of the present invention to solve those problems in the known techniques and to provide a machineroomless elevator system including an elevator hoist and capable of rationally disposing the elevator hoist in a limited space in a top part of an elevator shaft.

### Means for Solving the Problem

The present invention provides a machineroomless elevator system including: an elevator hoist installed in a top part of an elevator shaft; a cage; and a counterweight suspended so as to move vertically in a space on the outer side of either of the right or the left wall of the cage in the elevator shaft; wherein the elevator hoist has opposite first end second ends, and the elevator hoist is disposed such that a main sheave on the first end thereof is above the counterweight and the second end is above the rear end of the cage as viewed from above the elevator shaft.

In the machineroomless elevator system according to the present invention, the main sheave on the first end of the elevator hoist is above the counterweight and the second end of the elevator hoist is above the rear end of the cage as viewed from above the elevator shaft. Therefore, as viewed from above the elevator shaft, the center of gravity of the elevator hoist is not at a long distance from the counterweight, an a large bending moment will not be exerted on front and rear counterweight guide rails when the elevator hoist is supported on the counterweight guide rails. Since the second end of the elevator hoist corresponds to the rear end of the cage, devices mounted on the top wall of the cage can be easily arranged so that the devices may not interfere with the elevator hoist. The disposition of the elevator hoist such that the second end thereof is above the rear end of the cage can increase the degree of freedom of disposing the elevator hoist. Thus, main ropes suspending the cage can be extended so as to intersect a vertical line passing the center of gravity of the cage Moreover, since the second end, opposite the first end provided with the main sheave, of the elevator hoist is above the rear end of the cage, a dimension of the elevator shaft with respect to the depth of the cage does not need to be increased, which is necessary for placing the elevator hoist in the elevator shaft when the elevator hoist extends rearward beyond the rear end of the cage.

In the machineroomless elevator system according to the present invention, the elevator hoist is disposed such that the axis thereof extends at an angle to either of the right or the left wall of the cage as viewed from above the elevator shaft.

Such a disposition of the elevator hoist characterizes more concretely the construction of the machineroomless elevator system and clearly indicates that the elevator hoist is straight. The straight elevator hoist may have a small diameter and a length greater than the outside diameter of the main sheave.

In the machineroomless elevator system according to the present invention, the elevator hoist is mounted on an elevator hoist support member longitudinally extended between upper ends of the front and the rear counterweight guide rail, and end parts, suspending the counterweight, of the main ropes are attached to a part, near the second end of the elevator hoist, of the elevator hoist support member.

In the machineroomless elevator system according to the present invention, the second end, opposite the main sheave, of the elevator hoist is above the rear end of the cage and is not above the counterweight. Therefore, a hitch holding the end parts, suspending the counterweight, of the main ropes can be disposed on the elevator hoist support member at the same level as the elevator hoist.

Therefore, the hitch is not obliged to be disposed at a position below the elevator which where the hitch needs to be disposed when the second end, opposite the main sheave, of the elevator hoist is above the counterweight, and the vertical stroke of the counterweight does not need to be limited. Thus, the space in the elevator shaft can be still more effectively used by reducing the area of a horizontal section of the counterweight and increasing the length of the counterweight.

In the machineroomless elevator system according to the present invention, two cage suspending sheaves are mounted on the top wall of the cage so as to be point symmetrical with respect to the center of gravity of the cage as viewed from above the elevator shaft.

In the machineroomless elevator system according to the present invention, the first end provided with the main sheave of the elevator hoist is above the counterweight, and the second end of the elevator hoist is above the rear end of the cage. Therefore, the elevator hoist will not interfere with the two cage suspending sheaves mounted on the top wall of the cage, and structural members including a sheave support beam. Since the two cage suspending sheaves are disposed so as to be point symmetrical with respect to the center of gravity of the cage to suspend the cage in a gravitational center suspension mode, the cage can be suspended in a horizontal position, vibrations and noise generated by interference between the cage and the cage guide rails when the cage moves vertically can be lessened, and the comfort of passengers in the cage can be improved.

### EFFECT OF THE INVENTION

As apparent from the foregoing description, the elevator hoist of the machineroomless elevator system of the present invention can be rationally disposed in a limited space in the top part of the elevator shaft.

### BRIEF DESCRIPTION OF THE DRAWINGS

FIG. 1 is a perspective view of a machineroomless elevator system in a preferred embodiment according to the present invention;

FIG. 2 is a top view of the machineroomless elevator system shown in FIG. 1;

FIG. 3 is a top view of a machineroomless elevator system proposed in IP-A 2000-44147; and

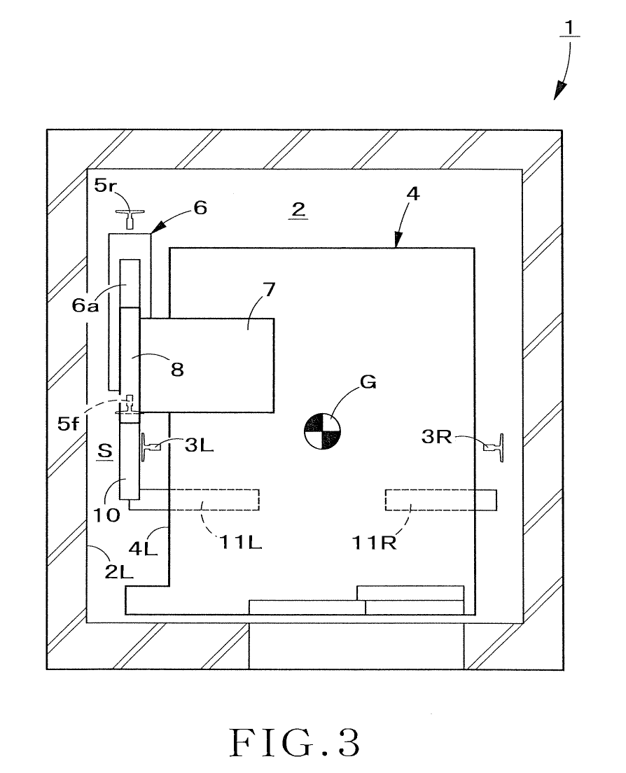

FIG. 4 is a left-hand side elevation of the machineroomless elevator system shown in FIG. 3.

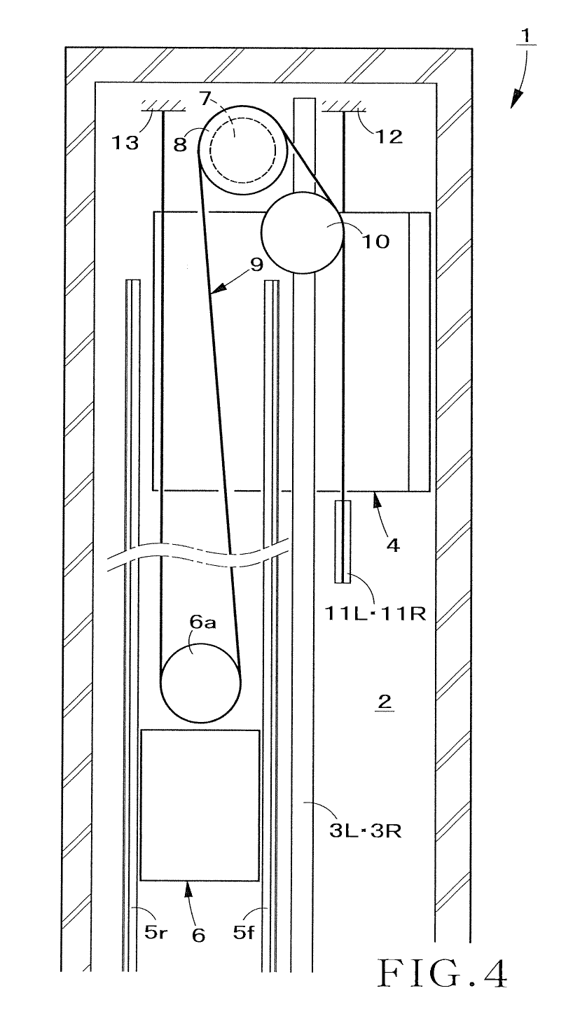

### REFERENCE CHARACTERS

11: Known machineroomless elevator system
2: Elevator shaft
20: Cage
21R and 21L: Cage guide rails
22: Counterweight
22a and 22bCage suspending sheaves
23R and 23L: Counterweight guide rails
24: Elevator hoist support member
25: Elevator hoist
26: Main sheave
27: Main rope
28: Top beam
29: Sheave support beam
30R and 30L: Cage suspending sheaves
31 and 32P Hitches
100: Machineroomless elevator system in an embodiment

### DESCRIPTION OF THE PREFERRED EMBODIMENTS

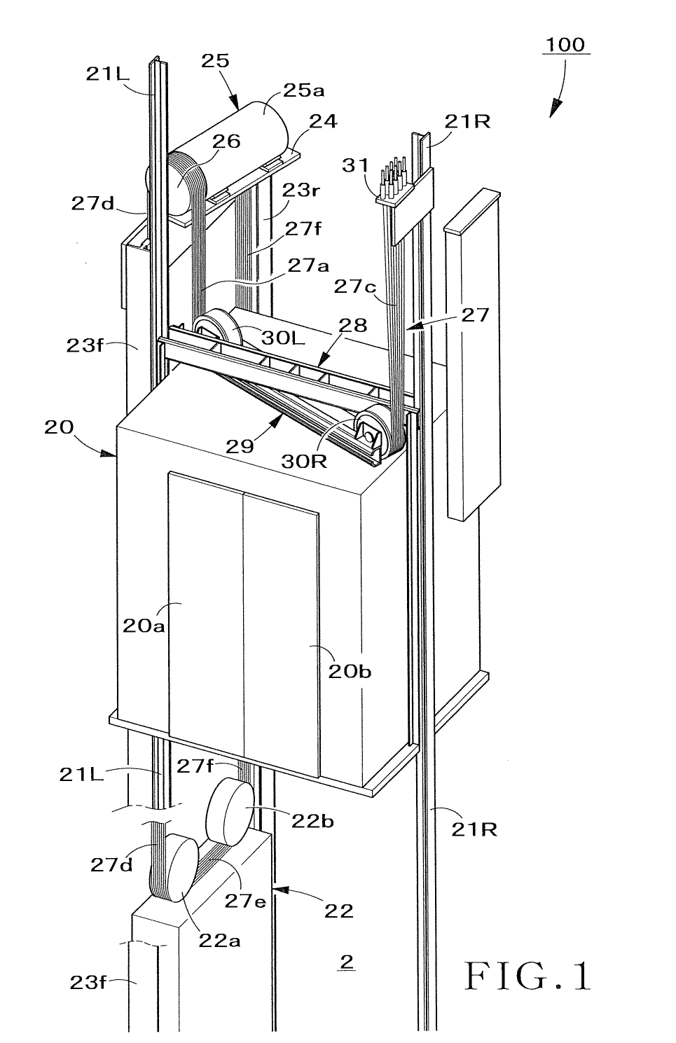

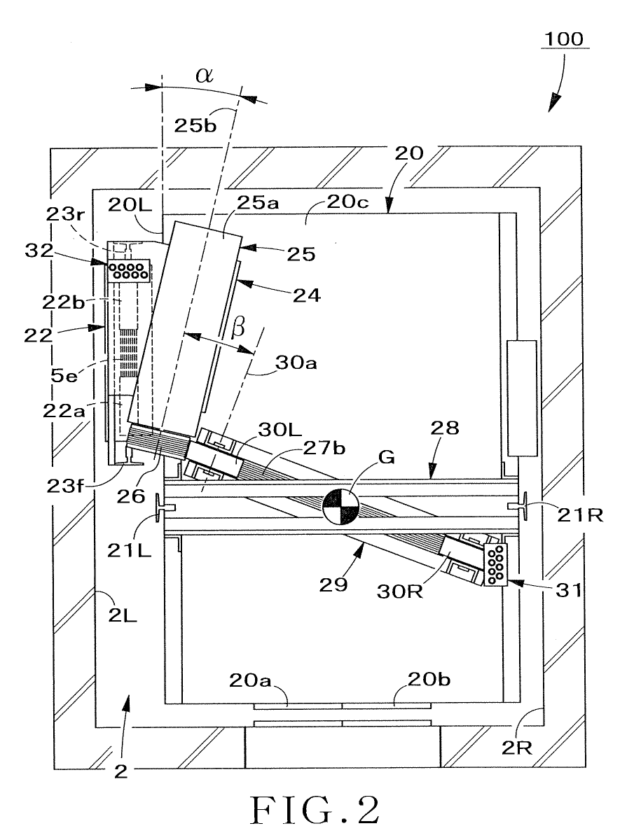

A machineroomless elevator system 100 in a preferred embodiment according to the present invention will be described with reference to FIGS. 1 and 2. In the following description, directions in which the doors of a cage move are referred to as lateral directions, a direction in which a passenger steps out of the cage is referred to as a forward direction, a direction in which a passenger steps into the cage is referred to as a rearward direction, and directions perpendicular to the lateral directions will be referred to as longitudinal directions.

In the machineroomless elevator system 100 shown in FIGS. 1 and 2, a cage 20 is guided for vertical movement in an elevator shaft 2 by a right cage guide rail 21R and a left cage guide rail 21L. The cage 20 is provided in its front wall with two paired doors 20a and 20b. The doors 20a and 20b move laterally for opening and closing operations.

A counterweight 22 is guided for vertical movement in a space on the left side of the cage 20 in the elevator shaft 2 by a front counterweight guide rail 23f and a rear counterweight guide rail 23r.

An elevator hoist support member 24 is extended between the respective upper ends of the counterweight guide rails 23f and 23r in a longitudinal direction. An elevator hoist 25 is fixedly mounted on the elevator hoist support member 24. A main sheave 26, which is driven for rotation by the elevator hoist 25, has a smallest necessary outside diameter dependent on the diameter of main ropes 27. Elevator hoist 25 has a small diameter similarly to the main sheave 27, and a long length. As shown in FIG. 2, as viewed from above the elevator shaft 2, a first end, on which the main sheave 26 is mounted, of the elevator hoist 25 is above the counterweight 22, and a second end, opposite the first end, of the elevator hoist 25 is above the rear end 20c of the cage 20. As shown in FIG. 2, the axis 25b of the elevator hoist 25 and that of the main sheave 26 extend at an angle α to the left side surface 20L of the cage 20, in other words, to the surface of the left wall 2L of the elevator shaft 2. The angle α is in the range of about 10° and about 15°. The angle α does not necessarily need to be in that range.

Main ropes 27 are wound round the main sheave 26 to suspend the cage 20 and the counterweight 22 in a well bucket suspension mode.

A top beam 28, namely, a member of a cage frame, is extended laterally in a horizontal position on the top wall of the cage 20. As shown in FIG. 2, a sheave support beam 29 is extended across the top beam 28 in a horizontal position in a space between the top beam 28 and the top surface 20d of the cage 20. The sheave support beam 29 is inclined at an angle to the lateral direction. The sheave support beam 29 is joined to the top beam 28 such that the upper surface of a middle part, with respect to length, of the sheave support beam 29 is contiguous with the lower surface of a middle part, with respect to length, of the top beam 28. A right cage suspending sheave 30R and a left cage suspending sheave 30L are supported rotatably on the sheave support beam 29. As shown in FIG. 2, the cage suspending sheaves 30R and 30L are point symmetrical with respect to the center G of gravity of the cage 20. As shown in FIG. 2, the respective axes of rotation of the cage suspending sheaves 30R and 30L, as viewed from above, are inclined at an angle β to the respective axes of the elevator hoist 25 and the main sheave 26. The angle β is in the range of about 5° to about 10°. The angle β does not necessarily need to be in that range.

The cage 20 is suspended by parts 27a extending down from the main sheave, parts 27b extending between the case suspending sheaves 30R and 30L, and parts 27c extending up from the right case suspending sheave 30R and attached to the right hitch 31 of the of the main ropes 27. Thus, the cage 20 is suspended by the main ropes 27 in a 2-to-1 rope arrangement. The counterweight 22 is suspended by parts 27d extending down from the main sheave 26, parts 27e horizontally extending between the counterweight suspending sheaves 22a and 22b, and parts 27f wound round and extending up from the rear counterweight suspending sheave 22b and attached to the left hitch 32 of the main ropes 27 Thus the counterweight 22 is suspended by the main ropes 27 in a 2-to-1 rope arrangement. The left hitch 32 is disposed on the upper surface of the elevator hoist support member 24 at a position near the second end, opposite the main sheave 26, of the elevator hoist 25, so that the left hitch 32 is at the same level as the elevator hoist 25.

In the machineroomless elevator system 100 in this embodiment, the first end, on the side of the main sheave 25, of the elevator hoist 25 is above the counterweight 22, the second end, opposite the main sheave 26, of the elevator hoist 25 above the rear end 20c of the cage 20 as viewed from above the elevator shaft 2. The center of gravity of the elevator hoist 25 is at a short distance from counterweight 22 with respect to a horizontal direction. Thus, a large bending moment will not be exerted on the counterweight guide rails 23f and 23r supporting the elevator hoist 25. Therefore, the counterweight guide rails 23f and 23r do not need to be formed in large dimensions to provide the counterweight guide rails 23f and 23r with excessively high rigidity.

As shown in FIG. 2, the rear end of the elevator hoist 25 is above the rear end 20c of the cage 20 as shown in FIG. 2. Therefore, the elevator hoist 25, differing from the elevator hoist 7 of the conventional machineroomless elevator system 1 laterally extended in a central part of the cage 4, allows various devices to be easily arranged on the top wall of the cage 20 so that the devices may not interfere with the elevator hoist 25.

The rear end 25a of the elevator hoist 25 is above the rear end 20c of the cage 20, and the axis 25b of the elevator hoist 25 and the axis of the main sheave 26 extend at the angle α to the left side surface 20L of the cage 20. Since the elevator hoist 25 does not extend rearward beyond the rear end 20c of the cage 20 such that the rear end 25a of the elevator hoist 25 is behind the rear end 20c of the elevator cage 20, a dimension of the elevator shaft 2 with respect to the depth of the cage 20 does not need to be increased, which is necessary for placing the elevator hoist 25 in the elevator shaft 2 when the elevator hoist 25 extends rearward beyond the rear end 20c of the cage 20.

In the machineroomless elevator system 100 in this embodiment, the rear end 25c of the elevator hoist 25 is above the rear end 20c of the cage 20 and is not above the counterweight 22. Therefore, the left hitch 32 fixedly holding ends of the main ropes 27 suspending the counterweight 22 can be placed on the elevator hoist support member 24 at the same level as the elevator hoist 25. Whereas the left hitch 32 needs to be disposed at a level lower than that of the elevator hoist 25 when the rear end 25a of the elevator hoist is above the counterweight 22, the left hitch 32 does not need to be disposed at a level lower than that of the elevator hoist 25 in this machineroomless elevator system 100. Therefore, the vertical stroke of the counterweight 22 is not limited by the left hitch 32. Consequently, the counterweight 22 can be formed in a long length and in a small horizontal sectional area, which enables the further effective use of the space in the elevator shaft 2.

Moreover, in the machineroomless elevator system 100 in this embodiment, the elevator hoist 25 will not interfere with the cage suspending sheaves 30R and 30L, and structural members including the sheave support beam 29 and the top beam 28 even though the case suspending sheaves 30R and 30L are disposed at right and left parts, respectively, on the top wall of the cage 20. Since the cage suspending sheaves 30R and 30L can be disposed so as to be point symmetrical with respect to the center G of gravity of the cage 20 to suspend the cage 20 in a gravitational center suspension mode, the cage 20 can be suspended in a horizontal position, vibrations and noise generated by interference between the cage 20 and the cage guide rails 21R and 21L when the cage 20 moves vertically can be lessened, and the comfort of passengers in the cage 20 can be improved.

Since the axis 25b of the elevator hoist 25 extends at the angle α to the left side surface 20L of the cage 20, it is possible to dispose the left cage suspending sheave 30L with its axis 30a thereof extended at the small angle β to the axis 25b of the elevator hoist 25. Since the twist angle of parts 27a, extending between the main sheave 26 and the left cage suspending sheave 30L, of the main ropes 27 can be thus limited to the smallest necessary angle, the angle between a plain containing each of rope grooves formed in the circumference of the main sheave 26 and a direction in which each of the main ropes 27 extends is small even in a state where the cage 20 has been raised to its top position and the vertical distance between the main sheave 26 and the left cage suspending sheave 20L is short. Consequently, it is possible to prevent the generation of noise and vibrations caused by the engagement of the main ropes 27 each formed by twisting strands with the rope grooves of the main sheave 26 and the left case suspending sheave 30L and to extend the life of the main ropes 27.

Although the machineroomless elevator system of the present invention has been specifically described, the present invention is not limited thereto in its practical application and many changes and variations are possible in the machineroomless elevator system specifically described herein. For example, although the elevator hoist 25 and the main sheave 26 are disposed near the left wall 2L of the elevator shaft 2 in the foregoing embodiment, the elevator hoist 25 and the main sheave 26 may be disposed near the right wall 2R of the elevator shaft 2.

1. A machineroomless elevator system comprising:
an elevator hoist installed in a top part of an elevator shaft;
a cage; and
a counterweight suspended so as to move vertically in a space on the outer side of either of a right or a left wall of the cage in the elevator shaft;
wherein the elevator hoist has opposite first and second ends, and the elevator hoist is disposed such that a main sheave on the first end thereof is above the counterweight and the second end thereof is above a rear end of the cage as viewed from above the elevator shaft.

2. The machineroomless elevator system according to claim 1, wherein the elevator hoist is disposed such that an axis thereof extends at an angle to either of the right or the left wall of the cage as viewed from above the elevator shaft.

3. The machineroomless elevator system according to claim 1, wherein the elevator hoist is mounted on an elevator hoist support member extended along a sidewall of the elevator shaft between a front and a rear counterweight guide rail, and end parts, suspending the counterweight, of the main ropes are attached to a part of the elevator hoist support member corresponding to the second end of the elevator hoist.

4. The machineroomless elevator system according to claim 1, wherein two cage suspending sheaves are mounted on the top wall of the cage so as to be point symmetrical with respect to the center of gravity of the cage as viewed from above the elevator shaft.

5. The machineroomless elevator system according to claim 2, wherein the elevator hoist is mounted on an elevator hoist support member extended along a sidewall of the elevator shaft between a front and a rear counterweight guide rail, and end parts, suspending the counterweight, of the main ropes are attached to a part of the elevator hoist support member corresponding to the second end of the elevator hoist.

6. The machineroomless elevator system according to claim 2, wherein two cage suspending sheaves are mounted on the top wall of the cage so as to be point symmetrical with respect to the center of gravity of the cage as viewed from above the elevator shaft.

7. The machineroomless elevator system according to claim 3, wherein two cage suspending sheaves are mounted on the top wall of the cage so as to be point symmetrical with respect to the center of gravity of the cage as viewed from above the elevator shaft.
